(19) United States
(12) Patent Application Publication
(10) Pub. No.: US 2006/0144270 A1
(43) Pub. Date: Jul. 6, 2006

(54) Photothermally sensitive compositions and system for CTP imaging processes

(76) Inventor: Prakash Seth, Jackson, TN (US)

Correspondence Address: PERMAN & GREEN, 425 POST ROAD, FAIRFIELD, CT, 06824, US

(21) Appl. No.: 11/028,795

(22) Filed: Jan. 4, 2005

(51) Int. Cl. B41N 1/00; B41N 1/08

(52) U.S. Cl. 101/453; 101/456

(57) ABSTRACT

Plates coated with compositions photothermally sensitive to multiple portions of the electromagnetic spectrum and useful for the preparation of lithographic printing plates, color proofing films and the like by computer to plate imaging processes comprising a solvent, cross-linkable polymers and monomers, and energy absorbing dye/laser dye/initiator/sensitizers, where the energy absorbing dye/laser dye/initiator/sensitizers are selected from dye/initiator/sensitizers having increased sensitivities to varying portions of the electromagnetic spectrum and where the sensitivity of the imaged plate is increased by pre-heating prior to development.

### BACKGROUND OF THE INVENTION

1. Field of the Invention

The invention relates to photothermally sensitive coating compositions useful for the preparation of lithographic printing plates, color proofing films and the like by computer to plate imaging processes.

2. Brief Description of Related Developments

The art of lithographic printing is based upon the immiscibility of oil and water, wherein the oily material or ink is preferentially retained by the image area and the water or fountain solution is preferentially retained by the non-image area. When a suitably prepared surface is moistened with water and an ink is then applied, the background or non-image area retains the water and repels the ink while the image area accepts the ink and repels the water. The ink on the image area is then transferred to the surface of a material upon which the image is to be reproduced, such as paper, cloth and the like. Commonly the ink is transferred to an intermediate material called the blanket, which in turn transfers the ink to the surface of the material upon which the image is to be reproduced.

A very widely used type of lithographic printing plate has a light-sensitive coating applied to an aluminum base support. The coating may respond to light by having the portion that is exposed become soluble so that it is removed in the developing process. Such a plate is referred to as positive working. Conversely, when that portion of the coating that is exposed becomes hardened, the plate is referred to as negative working. In both instances the image area remaining is ink-receptive or oleophilic and the non-image area or background is water-receptive or hydrophilic.

The differentiation between image and non-image areas is made in the exposure process where a film is applied to the plate with a vacuum to insure good contact. The plate is then exposed to a light source, a portion of which is composed of UV radiation. In the instance where a positive plate is used, the area on the film that corresponds to the image on the plate is opaque so that no light will strike the plate, whereas the area on the film that corresponds to the non-image area is clear and permits the transmission of light to the coating which then becomes more soluble and is removed. In the case of a negative plate the converse is true. The area on the film corresponding to the image area is clear while the non-image area is opaque. The coating under the clear area of film is hardened by the action of light while the area not struck by light is removed. The light-hardened surface of a negative plate is therefore oleophilic and will accept ink while the non-image area which has had the coating removed through he action of a developer is desensitized and is therefore hydrophilic.

Direct digital imaging of offset printing plates has become increasingly important in the printing industry. Advances in solid-state laser technology have made medium to high-powered diode lasers attractive energy sources for plate setters, particularly lasers emitting energy in the near infrared (800-850 mm) regions. The use of controlled laser exposure obviates the need to use a film or mask when making image exposures, thereby facilitating a platemaking operation.

There are a number of United States patents relating to imaging compositions which are sensitive to infrared energy and which contain one or a mixture of phenolic resins and at least one infra-red absorbing dye or pigment. Positive acting plates based on a mixture of a novolak or resole or polyhydroxy-styrene resin and an IR absorbing dye are disclosed in U.S. Pat. No. 6,063,544. Printing plates based on a mixture of a novolak resin, a resole resin, an infrared absorbing dye or pigment and a latent Bronstead acid are disclosed in U.S. Pat. Nos. 5,372,907, 5,372,915, 5,466,577, and 5,491,046. Exposure of these plates to infrared radiation decomposes the latent Bronstead acid to yield species that will serve to crosslink the resole and novolak resins, thereby hardening the mixture in the exposed areas. Further heating of the exposed plate tends to further harden the exposed coating which becomes insoluble in aqueous alkaline developer, while the non-exposed areas remain soluble in developer solution.

In addition, U.S. Pat. Nos. 5,705,322 and 5,858,626 disclose laser-imagable photosensitive elements based on one or a mixture of a phenolic resin and an o-diazonaphthoquinone derivative or the esterification product thereof with a phenolic resin and an infrared absorbing compound. Elements of the '322 patent are negative working and require image exposure first followed by floodlight exposure prior to development. Elements of the '626 patent are positive working and require no floodlighting prior to or after development.

One of the problems associated with these and similar systems is that there is often insufficient integrity of the image areas remaining after development of the printing plate to effectively perform the printing process over long printing runs, resulting in print images having less than desired resolution and print quality.

Existing aqueous photosensitive coatings have comparatively much slower exposure speed and need much higher UV energy (over 10 millijoules) and so are not usable with modern plate imaging technologies and equipment using UV lasers, UV light sources and other types of laser such as violet, thermal or 830 IR lasers. These computer to plate (CTP) applications include different laser types and therefore require photosensitive coatings optimized for and having increased sensitivity to different wavelengths e.g. 350 nm for UV lasers, 405 nm for violet lasers, 830 or 1064 nm for IR thermal lasers, etc.

Current plate making processing of conventional plates utilizing aqueous developer chemistries is relatively simple and utilizes a mild aqueous alkaline developer that does not contain strong solvents or highly corrosive materials. These developer systems are environmentally and user friendly. The developer does not oxidize upon exposure to, atmosphere unlike other developer chemistries.

There have been attempts to increase the sensitivity of conventional photosensitive plates by, for example, utilizing long and/or high temperature pre-bakes [temperatures in excess of 60 seconds for periods in excess of 250° F.] prior to development, and highly alkaline [pH of 13 or more] chemistries for developing the image. These developer chemistries are highly corrosive and have a short use life, primarily due to atmospheric oxidation. These factors increase the instability of the developer to the extent that costly special processing equipment is required making the entire process time consuming and very expensive to operate and maintain. Post processing of the plates is also normally required to increase the durability of the finished plate.

There are some IR 830 nm thermally sensitive plates available. However, these plates suffer from the dual disadvantages of producing ablated residue during imaging which must be removed from the plate by a debris removal system on the imaging device and/or of producing toxic fumes which are released during imaging using IR 830 nm IR lasers.

It is an object of this invention to provide compositions and methods for the CTP preparation of printing plates utilizing conventional equipment and standard operating procedures/methods.

It is an object of this invention to provide compositions and methods for the CTP preparation of printing plates utilizing mostly conventional raw materials.

It is an object of this invention to provide compositions and methods for the CTP preparation of printing plates utilizing safe, aqueous mildly alkaline developer chemistries and processing equipment.

It is an object of this invention to provide compositions and methods for the CTP preparation of printing plates utilizing developers that do not oxidize upon exposure to the atmosphere.

It is an object of this invention to provide compositions and methods for the CTP preparation of printing plates utilizing a short low temperature preheating step, and present plate processing equipment.

It is an object of this invention to provide compositions and methods for the CTP preparation of printing plates that do not produce toxic fumes and ablated coating residue when imaged with 830 nm IR lasers.

It is an object of this invention to provide compositions and methods for the CTP preparation of printing plates having a press life of over one million impressions.

It is an object of this invention to provide a photosensitive plate having increased sensitivity to match the higher speed requirements of CTP plate imaging technologies and devices.

It is an object of this invention to provide a universal photosensitive plate that allows the plate to match higher speed requirement of modern CTP plate imaging technologies and devices using light sources of varying spectrums.

### SUMMARY OF THE INVENTION

Disclosed is a system comprising components suitable for use in CTP plate making where a plate substrate, preferably aluminum, is coated with a photothermally sensitive multi-component composition, imaged in a CTP plate making device, thermally treated to crosslink portions of the coating and the image developed. An optional post heating significantly increases the functional life of the plate.

The new coating compositions are usable with modern plate imaging technologies and equipment using UV lasers, UV light sources and other types of lasers such as violet, thermal or 830 IR lasers. These computer to plate (CTP) applications include different laser types and therefore require photosensitive coatings optimized for and having increased sensitivity to different wavelengths e.g. 350 nm for UV lasers, 405 nm for violet lasers, 830/1064 nm for IR thermal lasers, 800-850 for IR lasers, etc.

The superior results derived from the use of this system are dependent upon the selection of components that are contained in the photothermally sensitive coating composition and the provision of a pre-heating step with specified temperature and duration parameters conducted post-imaging and pre-development.

The disclosed compositions achieve their desirable characteristics in part due to a preheating step provided after imaging the plate, but before development of the image by an aqueous alkaline developer. In the absence of a preheating step current technologies need a significantly higher-level energy to image the plate, hence become impracticable or unwieldy with computer-to-plate (CTP) lasers or UV light source applications.

These and other benefits are obtained by the compositions and processes disclosed by making the plates more photo-thermally sensitive and responsive to the target wavelength of the light source by adding appropriate dyes/energy absorbers having maximum λ absorption at or close to corresponding wavelength imaging energy source. The speed of the composition can be intimately matched to the energy input level during imaging by modifying the concentration of photo initiators to match required exposure speed. Specified dyes are included in the composition to increase absorption at the wavelength of the imaging energy. The combination of the specified dyes and other components combined with the pre-heating step results in a universal imaging plate, sensitive to energy sources of differing wavelengths and able to replace multiple types of plates each having a single area of increased sensitivity.

The process of preparing the disclosed compositions comprises the steps of

1] sequentially mixing the components of the photothermally sensitive composition;

2] applying the photothermally coating composition to the plate substrate;

3] optionally applying a protective coating onto the coated substrate;

4] imaging the coated substrate;

5] thermally treating the coated imaged substrate;

6] developing the image; and

7] optionally post-heating the developed substrate.

The disclosed system utilizes a photothermally sensitive composition coated on a substrate and a post-imaging, pre-developing heating procedure to produce a long life printing plate responsive to low energy imaging and with long press life and excellent resolution.

The photothermally sensitive composition comprises a solvent, cross-linkable polymers and monomers, energy absorbing dye/laser dye/initiator/sensitizers, optional plasticizers and optional additives such as dyes or colorants. Preferred components are:

1] a solvent selected from a glycol ether. MEK, alcohol and mixtures thereof, such as EE [ethylene glycol monoethyl ether] or PM [propylene glycol methyl ether], EB [ethylene glycol monobutyl ether]. Glycol ethers are preferred.

2] a high mol wt acrylate binder

3] TLA-454 [4,4′-methylenebis(N,N-dimethyl)benzenamine] (initiator/sensitize)r.

4] CDM-HABI [1,1′-Bi-1H-imidazole, 2,2′-bis(2-chlorophenyl)-4,4′,5,5′-tetrakis(3-methoxyphenyl)] ( initiator).

5] OCL-HABI

6] BDMABP [Michler's ketone] [4,4′-bis-(dimethylamino)benzophenone]

7] a triazine such as A, D, or S [2,4,6-tris(1-aziridinyl)-s-triazine preferred)

8] a colorant dye such as B. Blue 007, Sol. Red—109

9] an IR 830 dye

10] a 405 nm dye/sensitizer [coumarine 30 or methane cyanine preferred]

11] a plasticizer (preferably a mixed ester of triethylene glycol, di-caprate and dicaprylate mfg. by PVO International]

12] a low mol. wt. acrylate monomer (100-1500, preferably 200-600)

13] a multifunctional [tetra or penta functional preferred] acrylate with TMPTA [trimethylolpropane triacrylate) being preferred.

Where the imaging is accomplished utilizing a violet laser with a target wavelength at or close to 405 nm for coumarine and methane cyanine dyes having λ max at 415 nm & 404 nm respectively are utilized.

Where the imaging is accomplished utilizing a IR 830 thermal laser with a target wavelength at or close to 830 nm IR 830 dyes such as polymethine, squarilium, pyrilium type IR dyes are utilized. Polymethine dyes are preferred and may added with an optional photoacid generator such as a triazine.

In the process of manufacturing photothermally sensitive polymerizable coating emulsions, the components are slowly added to solvent under agitation with the help of mixer to dissolve completely. It is preferred that the components are added in the following sequence:

Solvent EE or PM, EB [glycol ethers]

high mol wt acrylate binder

TLA-454

CDM-HABI

OCL-HABI

BDMABP [Michler's ketone]

Triazine A, D, S [S preferred]

Colorant dye B. Blue 007, Sol. Red—109

IR 830 dye

405 nm dye/sensitizer Coumarine 30, Coumarine 102 or methane cyanine [preferred]

Psc Plasticizer

low mol. wt. acrylate monomer

TMPTA or other multi-functional acrylate

The proportion of each component is as follows:

| | Energy Source - [% in wt/wt solids] | | |
|---|---|---|---|
| | | Violet Laser | Thermal IR- |
| Components | UV Laser | [30 nwatt] | 830/1064 Laser |
| glycol | 50-90% | same | same |
| ether | 55-75% | | |
| solvent | preferred | | |
| HMW | 20-60% | same | same |
| acrylate | 35-55% | | |
| | preferred | | |
| TLA-454 | 1-5% | same | same |
| | 1.5-2.5% | | |
| | preferred | | |
| CDM-HABI | 1-6% | same | same |
| | 1.5-3.0% | | |
| | preferred | | |
| OCL-HABI | 1-6% | same | same |
| | 1.5-3.0% | | |
| | preferred | | |
| BDMABP | 0.5-5% | same | same |
| | 1-1.5% | | |
| | preferred | | |
| Triazine | 0.5-5% | 1-20% | 1-20% |
| | 1-1.5% | 5-6% | 5-6% |
| | preferred | preferred | preferred |
| Colorant | 0.5-5% | same | same |
| | 1.0-2.0% | | |
| | preferred | | |
| IR 830 dye | Nil | Nil | 0.5-5.0% |
| | | | 1.0-2.- % |
| | | | preferred |
| 405 nm | Nil | 0.5-5.0% | Nil |
| dye/sensitizer | | 1.0-2.- % | |
| | | preferred | |
| Sc | 1-10% | Same | Same |
| Plasticizer | 5-8% | | |
| | preferred | | |
| LMW | 10-70% | Same | Same |
| acrylate | 25-55% | | |
| monomer | preferred | | |
| Multi- | 10-70% | Same | Same |
| functional | 25-55% | | |
| acrylate | preferred | | |

The components of the coating are mixed in the order listed at or above ambient temperature, preferably in the range of from about 70 to 80° F. to make up a solution containing from about 5 to about 50% solids, preferably from about 25 to about 35% solids.

The coating composition is coated on the plate substrate. The preferred substrate for the printing plate is aluminum, most preferably aluminum alloys of the 1000 and 3000 series. Especially useful in the process are aluminum substrates having a gauge/thickness of from about 0.004 to about 0.020 inch; and a width of up to about 60 inches.

Aluminum substrates that have been mechanically or electrochemically grained and anodized and sealed with alkali silicate or PVPA work well in the process. Aluminum substrates that have been post anodicly sealed with PVPA are especially preferred. Aluminum substrates that have been anodized and sealed show a marked improvement in adhesion of the photothermally sensitive layer. Furthermore, without post anodizing and sealing, the background of the plate (the non-image area) is prone to sensitivity when put on the press and the shelf life of the product is not as good.

The photothermally sensitive coating is applied to the substrate in an amount sufficient to provide a coating weight of from about 1 to about 90 mg/dm², preferably from about 10 to about 30 mg/dm². After coating the substrate is dried at a temperature in the range of from about 150 to about 250° F., preferably at a temperature in the range of from about 170 to about 200° F., for a period sufficient to dry the coating, typically from about 15 seconds to about 3 minutes, preferably from about 45 to about 90 seconds.

To prevent coating degradation is it desirable to cover it with a protective over coat/oxygen barrier. A suitable topcoat comprises the following components

water

Vinyl 107 &/or 203

Polyvinylpyrrolidone/vinyl acetate S-630

Ethyl Cellusolve

Triton X-100

3A alcohol

The top coat composition remains the same for each type of photothermally sensitive layer and comprises from about 70 to about 95% water, preferably about 80 to 90% water, to which are added

1] vinyl 107 or 203 or a mixture thereof, preferably in equal amounts, to comprise from about 0.5 to about 30% by weight of the solution, preferably about 10 to about 20%, and

2] the other components listed above, each in an amount of from about 0.1 to about 10% by weight, preferably about 1 to about 2% by weight.

The protective topcoat is produced by slowly adding, under constant agitation with a mixer, vinyl or a mixture of vinyls and PVP-VA, into water to completely dissolve the polymers. The mixture is then hot digested for a period of from about 1 to about 3 hours, preferably about 2 hours, at a temperature in the range of from about 100° F. to about 200° F., preferably in the range of from about 180° F. to about 210° F.

The solution is allowed to cool to below 90° F. Alcohol and wetting agent X-100 are then added and mixed into the solution. The concentration of the solution is adjusted to contain from about 1 to about 30% solids, preferably from about 10 to about 15% solids.

The protective topcoat is applied to the substrate in an amount sufficient to provide a coating weight of from about 1 to about 50 mg/dm². After coating the substrate is dried at a temperature in the range of from about 50 to about 250° F., preferably at a temperature in the range of from about 100 to about 200° F., for a period sufficient to dry the coating, typically from about 5 seconds to about 2 minutes, preferably from about 20 to about 60 seconds.

The appropriate type of CTP plate depending on the wavelength of the light source is imaged in an imaging device such as a plate setter in the conventional manner for such devices.

In a critical step, the imaged plate is then preheated to a temperature in the range of from about 140 to about 250° F., preferably in the range of about 180 to about 230° F. for a period of from about 5 to about 120 seconds, preferably from about 10 to about 30 seconds.

After cooling to room temperature, the plate is developed with aqueous alkaline developer.

The aqueous alkaline developer is primarily comprised of water and an alkali compound. Alkali hydroxide or alkali (sodium most preferred) carbonates are preferred at concentrations in the range of from about 1.0 to about 1.5%. At a pH of 12-13 the developer is corrosive and oxidation prone. However at a pH of 11.5 or below the developer doesn't oxidize

The image on the plate produced by the described process has very good resolution and a long press life for high quality commercial printing applications.

To increase the press life even further, the plate may be post baked at a temperature in the range of from about 350 to about 550° F., preferably at a temperature in the range of from about 450 to about 535° F. for a period of from about 15 to about 5000 seconds; preferably form about 60 to about 90 seconds to significantly harden the image thereby providing increased press wear resistance and chemical resistance to allow extended press life.

1. coating compositions photothermally sensitive to multiple portions of the electromagnetic spectrum and useful for the preparation of lithographic printing plates, color proofing films and the like by computer to plate imaging processes comprising a solvent, cross-linkable polymers and monomers, energy absorbing dye/laser dye/initiator/sensitizers, optional plasticizers and optional additives where the energy absorbing dye/laser dye/initiator/sensitizers are selected from dye/initiator/sensitizers having increased sensitivities to varying portions of the electromagnetic spectrum.

2. The coating composition of claim 1 where the sensitivity of the imaged coating composition is increased by heat treatment before development.

3. Photothermally sensitive coating compositions useful for the preparation of lithographic printing plates, color proofing films and the like by computer to plate imaging processes comprising a solvent, cross-linkable polymers and monomers, energy absorbing dye/laser dye/initiator/sensitizers, optional plasticizers and optional, additives where the solvent is selected from the group consisting of a glycol ether, MEK, alcohol and mixtures. thereof, the cross-linkable polymer is a high molecular weight acrylate, the monomer is a low mol. wt. acrylate monomer, the energy absorbing dye/laser dye/initiator/sensitizers are selected from [4,4,-methylenebis (N,N-dimethyl)benzenamine), [1,1′-Bi-1H-imidazole, 2,2′-bis(2-chlorophenyl)-4,4′,5,5′-tetrakis(3-methoxyphenyl)], OCL-HABI, [4,4′-bis (dimethylamino)benzophenonel, a triazine, an IR 830 dye, a multifunctional [tetra or penta functional preferred] acrylate, a 405 nm dye/sensitize and mixtures thereof.

4. The composition of claim 3 where solvent is a glycol ether, the colorant dye is Blue 007 or Sol. Red—109, the 405 nm dye/sensitizer is coumarine 30 or methane cyanine, the low mol. wt. acrylate monomer has a molecular weight of 100-1500 daltons, and the multifunctional acrylate is tetra or penta functional.

5. The composition of claim 3 where solvent is selected from ethylene glycol monoethyl ether, propylene glycol methyl ether, ethylene glycol monobutyl ether and mixtures thereof, the triazine is 2,4,6-tris(1-aziridinyl)-s-triazine, the 405 nm dye/sensitizer is coumarine 30 or methane cyanine, the low mol. wt. acrylate monomer has a molecular weight of 200-600 daltons, and the multifunctional acrylate is trimethylolpropane triacrylate

6. A process for making a photothermally sensitive coating compositions useful for the preparation of lithographic printing plates, color proofing films and the like by computer to plate imaging processes comprising
1] sequentially mixing the components of the photothermally sensitive composition;
2] applying the photothermally coating composition to the plate substrate;
3] optionally applying a protective coating onto the coated substrate;
4] imaging the coated substrate;
5] thermally treating the coated imaged substrate; and
6] developing the image.

7. The process of claim 6 where the thermally treating step is conducted at a temperature in the range of from about 140 to about 250° F. for a period of from about 5 to about 120 seconds.

8. The process of claim 6 where the thermally treating step is conducted at a temperature in the range of from about 180 to about 230° F. for a period of from about 10 to about 30 seconds.

9. The process of claim 4 where the developed substrate is post baked at a temperature in the range of from about 350 to about 550° F. for a period of from about 15 to about 5000 seconds.

10. The process of claim 4 where the developed substrate is post baked at a temperature in the range of from about 450 to about 535° F. for a period of from about 60 to about 90 seconds.

11. A lithographic plate comprising the photothermally sensitive coating of claim 1 on a substrate where the coating is present in an amount sufficient to provide a coating weight of from about 1 to about 90 mg/dm².

12. A lithographic plate comprising a substrate, the photothermally sensitive coating of claim 1 where the coating is present in an amount sufficient to provide a coating weight of from about 1 to about 90 mg/dm² and a topcoat comprising water, vinyl 107 or 203, polyvinylpyrrolidone/vinyl acetate S-630, ethyl cellusolve, Triton. X-100, and 3A alcohol.

13. The lithographic plate of claim 12 where the topcoat comprises from about 70 to about 95% water, vinyl 107 or 203 or a mixture thereof in an amount of from about 0.5 to about 30% by weight of the solution, and the other specified components, each in an amount of from about 0.1 to about 10% by weight.
